(19) United States
(12) Patent Application Publication
(10) Pub. No.: US 2025/0090980 A1
(43) Pub. Date: Mar. 20, 2025

(54) RESERVE TANK

(71) Applicant: TOYOTA JIDOSHA KABUSHIKI KAISHA, Toyota-shi (JP)

(72) Inventor: Yutaroh GOTOH, Toyota-shi (JP)

(73) Assignee: TOYOTA JIDOSHA KABUSHIKI KAISHA, Toyota-shi (JP)

(21) Appl. No.: 18/661,926

(22) Filed: May 13, 2024

(30) Foreign Application Priority Data
Sep. 20, 2023 (JP) 2023-151910

(51) Int. Cl. B01D 19/00; F01P 11/02

(52) U.S. Cl. CPC B01D 19/0057; F01P 11/029

(57) ABSTRACT

The reserve tank according to the present disclosure is a reserve tank for storing coolant of a vehicle, and includes a substantially cylindrical gas-liquid separation unit, an inlet provided on a side surface of the gas-liquid separation unit and allowing coolant to flow into the gas-liquid separation unit, and an outlet provided on a bottom surface of the gas-liquid separation unit and allowing coolant to flow out from the inside of the gas-liquid separation unit. By providing a partition portion inside the gas-liquid separation unit so as to divide the coolant flowing from the inlet, a plurality of internal spaces is formed in the gas-liquid separation unit, and the center position of the outlet is a position deviated from the center position of the swirling flow of the coolant generated in each internal space.

### CROSS-REFERENCE TO RELATED APPLICATION

This application claims priority to Japanese Patent Application No. 2023-151910 filed on Sep. 20, 2023, incorporated herein by reference in its entirety.

### BACKGROUND

### 1. Technical Field

The present disclosure relates to a reserve tank.

### 2. Description of Related Art

In a circulation path for coolant for cooling an internal combustion engine of a vehicle, a reserve tank that temporarily stores the coolant is attached to a radiator that cools the coolant heated by the internal combustion engine. When the flow velocity of the coolant is increased in order to improve the cooling performance, bubbles generated in the circulation path may flow into the reserve tank, or bubbles may be generated in the reserve tank. If such bubbles are circulated as they are to the circulation path, the cooling performance is deteriorated. Therefore, in order to improve the cooling performance, there has been developed a technique of separating the coolant and the air bubbles in the reserve tank.

For example, Japanese Unexamined Patent Application Publication No. 2021-169815 (JP 2021-169815 A) discloses a reserve tank capable of generating and removing bubbles. In the reserve tank disclosed in JP 2021-169815 A, a protruding portion formed so as to extend along the axis from a bottom wall portion of a gas-liquid separation unit is provided inside the gas-liquid separation unit. In the reserve tank disclosed in JP 2021-169815 A, a swirling flow is generated inside the gas-liquid separation unit to centrifuge bubbles.

### SUMMARY

In the reserve tank disclosed in JP 2021-169815 A described above, the flow velocity increases from the inside to the outside of the swirling flow when the flow rate is increased in order to improve the cooling performance. Therefore, the bottom portion of the swirling flow comes into contact with the distal end portion of the protruding portion, and the swirling flow is disturbed to generate bubbles in some cases. In order to suppress this, it is effective to increase the capacity of the reserve tank and reduce the flow velocity, but there is also a limitation on the space in the vehicle. As described above, the reserve tank disclosed in JP 2021-169815 A has room for improvement in the cooling performance.

The present disclosure has been made in view of such circumstances, and provides a reserve tank capable of improving the cooling performance.

An aspect of the present disclosure provides
a reserve tank that stores coolant of a vehicle, including:
a gas-liquid separation unit in a substantially cylindrical column shape;
an inlet provided in a side surface of the gas-liquid separation unit to allow the coolant to flow into an inside of the gas-liquid separation unit; and
an outlet provided in a bottom surface of the gas-liquid separation unit to allow the coolant to flow out of the inside of the gas-liquid separation unit, in which:
a plurality of internal spaces is formed in the gas-liquid separation unit by providing a partition portion inside the gas-liquid separation unit so as to divide the coolant flowing in from the inlet; and
a center position of the outlet is a position deviated from a center position of a swirling flow of the coolant generated in each of the internal spaces.

In the reserve tank according to the present disclosure, the coolant from the inlet is divided, and therefore a swirling flow is generated while ensuring an appropriate flow velocity, and the bubbles can be separated in the gas-liquid separation unit. Since the center position of the outlet is deviated from the center position of the swirling flow, it is possible to suppress the separated bubbles flowing out from the outlet, and therefore it is possible to improve the cooling performance.

The partition portion may be provided so as to divide the coolant flowing out from the outlet. With such a configuration, the partition portion is disposed directly above the outlet, and therefore the center position of the outlet is deviated from the center position of the swirling flow, and it is possible to suppress the separated bubbles flowing out from the outlet. Therefore, the cooling performance can be improved.

The partition portion may be provided so as to equally divide the coolant flowing out from the outlet. With such a configuration, the size of the outlet is equal with respect to each of the internal spaces of the gas-liquid separation unit, and therefore it is possible to further suppress the separated bubbles flowing out from the outlet. Therefore, the cooling performance can be improved.

The partition portion may be provided so as to equally divide the coolant flowing out from the inlet; and the center position of the outlet may be the same position as a center of the gas-liquid separation unit. With such a configuration, the coolant from the inlet equally flows into the internal spaces of the gas-liquid separation unit, and therefore a swirling flow is generated while ensuring an appropriate flow velocity, and the bubbles can be separated in the gas-liquid separation unit. Since the size of the outlet is equal with respect to each of the internal spaces of the gas-liquid separation unit, it is possible to further suppress the separated bubbles flowing out from the outlet. Therefore, the cooling performance can be improved.

A shielding plate that protrudes upward from the bottom surface of the gas-liquid separation unit may be provided between the inlet and the outlet. With such a configuration, it is possible to suppress the coolant having flowed into the gas-liquid separation unit from the inlet flowing out from the outlet as it is. Therefore, the cooling performance can be improved.

According to the present disclosure, it is possible to provide a reserve tank capable of improving the cooling performance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view (xy plan view) of a reserve tank according to a first embodiment;

FIG. 2 is a cross-sectional view (xz cross-sectional view) of a reserve tank according to a first embodiment;

FIG. 3 is a cross-sectional view (yz cross-sectional view) of a reserve tank according to the first embodiment;

FIG. 4 is a plan view (xy plan view) of a reserve tank according to a modification;

FIG. 5 is a cross-sectional view (yz cross-sectional view) of a reserve tank according to a second embodiment; and

FIG. 6 is a cross-sectional view (yz cross-sectional view) of the reserve tank according to the second embodiment.

### DETAILED DESCRIPTION OF EMBODIMENTS

Hereinafter, the present disclosure will be described through embodiments of the disclosure, but the disclosure according to the claims is not limited to the following embodiments. Further, not all of the configurations described in the embodiments are essential as means for solving the problem. For clarity of explanation, the following description and the drawings are omitted and simplified as appropriate. In the drawings, the same elements are denoted by the same reference numerals, and redundant descriptions are omitted as necessary. It should be understood that the right-hand system xyz Cartesian coordinates illustrated in the drawings are for convenience of describing the positional relation of the constituent elements. Usually, the positive z-axis is vertically upward and xy plane is a horizontal plane.

### First Embodiment

### Configuration of the Reserve Tank

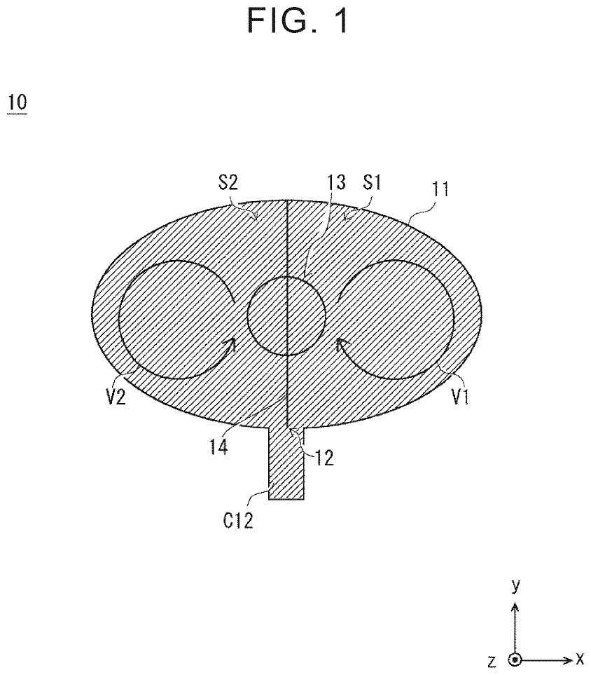

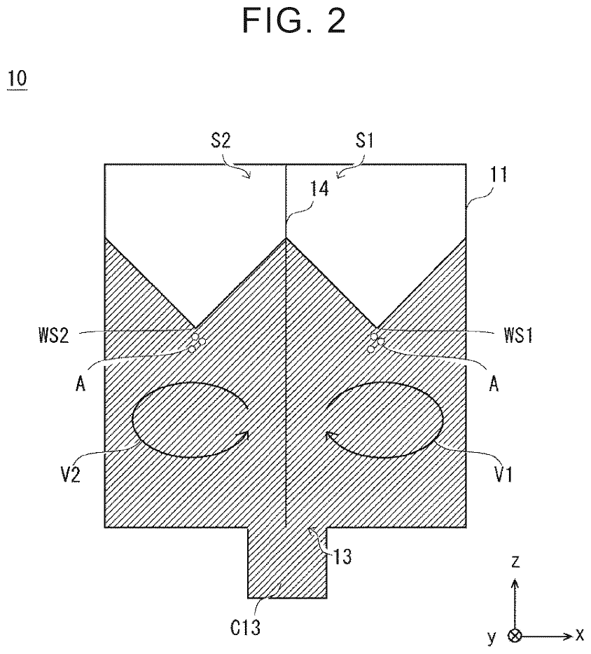

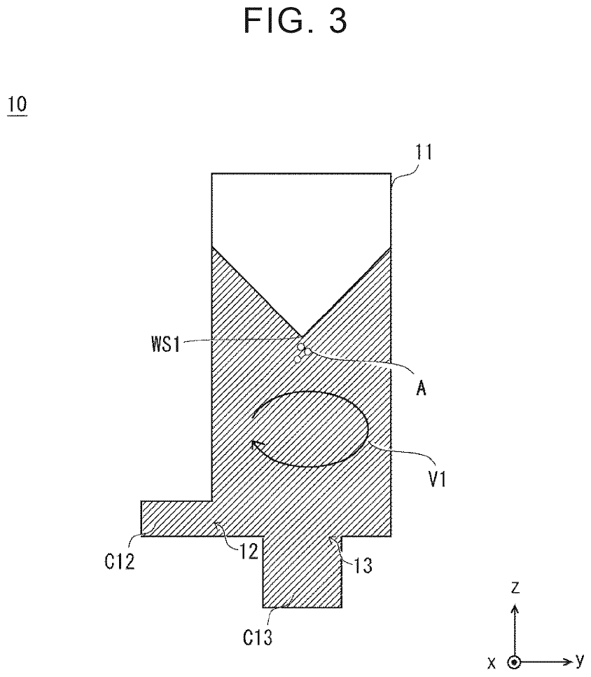

First, the reserve tank according to the first embodiment will be described with reference to FIGS. 1 to 3. FIG. 1 is a plan view (xy plan view) of a reserve tank according to a first embodiment. FIG. 2 is a cross-sectional view (xz cross-sectional view) of the reserve tank according to the first embodiment. FIG. 3 is a cross-sectional view (yz cross-sectional view) of the reserve tank according to the first embodiment.

An outline of the reserve tank 10 illustrated in FIGS. 1 to 3 will be described. The reserve tank 10 is used in a cooling system mounted on a vehicle. The cooling system cools each part of the vehicle to be cooled, for example, an internal combustion engine or auxiliary equipment, by circulating coolant. In a cooling system, coolant pumped by a water pump is supplied to a cooling target to cool the cooling target. coolant that has passed through the cooling target and becomes a high temperature is cooled in the radiator, returned to the water pump, and is pumped from the water pump again.

The reserve tank 10 is provided in such a cooling system at a position on the middle of a path through which the coolant circulates, for example, at a position on the upstream side of the water pump. The reserve tank 10 stores coolant for cooling the cooling target of the vehicle. In the examples shown in FIGS. 1 to 3, hatching indicates coolant.

Next, each configuration of the reserve tank 10 will be described. As illustrated in FIG. 1, the reserve tank 10 includes a gas-liquid separation unit 11, an inlet 12, an outlet 13, and a partition portion 14. A hose (not shown), a radiator (not shown), a water pump (not shown), and a cooling target (not shown) are connected between the inlet 12 and the outlet 13, and constitute a flow path through which the coolant circulates. Hereinafter, a flow path (not shown) through which the coolant circulates is referred to as a circulation flow path.

The gas-liquid separation unit 11 will be described. As illustrated in FIGS. 1 to 3, the gas-liquid separation unit 11 has a substantially cylindrical shape. The gas-liquid separation unit 11 is a container for separating air bubbles contained in the cooling while temporarily storing the supplied coolant.

In the embodiment illustrated in FIG. 1, the gas-liquid separation unit 11 has an elliptical shape in a xy plan view. However, the present disclosure is not limited thereto, and the gas-liquid separation unit 11 may have a closed shape such as a circle. In other words, a substantially circular cylinder is a column consisting of two substantially circular parallel planes including not only a true circle but also an ellipse or an oval, and the like, and a side surface connecting these two planes. A method of separating bubbles in the gas-liquid separation unit 11 will be described later.

The inlet 12 will be described. As illustrated in FIGS. 1 and 3, the inlet 12 is provided on a side surface of the gas-liquid separation unit, and allows the coolant to flow into the gas-liquid separation unit 11. As illustrated in FIGS. 1 and 3, the inlet 12 indicates an opening provided in a side surface of the gas-liquid separation unit. An inflow connection port C12 is provided in the reserve tank 10, and a hose is connected to the inflow connection port C12. Part of the coolant that does not pass through the radiator (not shown) flows into the gas-liquid separation unit 11 through the inlet 12.

The outlet 13 will be described. As illustrated in FIGS. 1 to 3, the outlet 13 is provided on the bottom surface of the gas-liquid separation unit, and allows the coolant to flow out from the inside of the gas-liquid separation unit. As shown in FIGS. 2 and 3, the outlet 13 shows an opening provided in the bottom surface of the gas-liquid separation unit. The reserve tank 10 is provided with an outflow connection port C13 to which the outflow connection port C13 is connected. When a water pump (not shown) is operated, the coolant stored in the gas-liquid separation unit 11 is supplied to the cooling target through the outlet 13.

The partition portion 14 will be described. As shown in FIGS. 1 and 2, the partition portion 14 is provided inside the gas-liquid separation unit 11 so as to divide the coolant flowing in from the inlet 12. As shown in FIG. 1, the partition portion 14 has a plane parallel to the y-axis, and is provided in the gas-liquid separation unit 11 from the side surface of the gas-liquid separation unit 11 having the inlet 12 to the other side surface of the gas-liquid separation unit 11.

More specifically, in the examples shown in FIGS. 1 and 2, the partition portion 14 is provided so as to divide the coolant flowing in from the inlet 12 equally. In the embodiments illustrated in FIGS. 1 and 2, two internal spaces S1, S2 are formed in the gas-liquid separation unit 11 by the partition portion 14. The volume of the coolant flowing into the internal space S1 and the internal space S2 is equal.

In the examples shown in FIGS. 1 to 3, the partition portion 14 is provided so as to divide the coolant flowing out from the outlet 13 equally. More specifically, the partition portion 14 is provided directly above the outlet 13, and the center position of the outlet 13 is the same position as the center of the gas-liquid separation unit.

### Swirling Flow

Next, the swirling flow generated in the gas-liquid separation unit 11 will be described with reference to FIGS. 1 to 3. In FIGS. 1 to 3, the swirling flow V1, V2 generated in the gas-liquid separation unit 11 is schematically indicated by arrows. The swirling flow V1, V2 occurs when the flow rate of the coolant is increased in order to improve the cooling performance. As shown in FIGS. 1 to 3, in the swirling flow V1, V2, since the flow velocity increases from the inside to the outside of the swirling flow, the liquid level increases from the inside of the swirling flow to the outside of the swirling flow. In other words, in the swirling flow V1, V2, the center has a recessed configuration. In the exemplary embodiments illustrated in FIGS. 1 to 3, the center of the swirling flow V1, V2 changes linearly, but may be a mortar shape having a gentle slope.

In the swirling flow V1, V2, bubbles contained in the coolant are centrifuged. The air bubbles contained in the coolant are, for example, air bubbles contained in the coolant supplied from the outlet 13 without being centrifuged in the gas-liquid separation unit 11 and returned to the inlet 12 as it is. As another example, the air bubbles contained in the coolant are air bubbles generated in the circulation path.

Referring to FIGS. 1 to 3, the centrifugation of the air bubble A in the swirling flow V1, V2 will be described in more detail. In order to improve the cooling performance, even if the flow rate of the coolant is increased, as shown in FIG. 1, since the partition portion 14 is provided in the gas-liquid separation unit 11, the coolant from the inlet 12 is equally divided. As a result, the coolant flows into the internal space S1, S2 equally. As a result, in the internal space S1, S2, the coolant flows along the wall surface of the partition portion 14, so that a swirling flow V1, V2 is generated while ensuring an appropriate flow velocity.

As the swirling flow V1, V2 as shown in FIGS. 2 and 3 is formed in the internal space S1, S2, the coolant in the internal space S1, S2 flows toward the outer side of the swirling flow V1, V2 by centrifugal force, that is, toward the side surface of the gas-liquid separation unit 11. On the other hand, since the air bubbles A contained in the coolant are lighter than the coolant, they are collected in the vicinity of the center of the swirling flow V1, V2 of the coolant. The air bubbles A are collected in a space above the gas-liquid separation unit 11 by reaching the liquid level WS1, WS2 of the coolant. Through such a process, bubbles contained in the coolant can be separated.

In other words, although the flow rate of the coolant flowing into the reserve tank is increased, since the coolant is divided and flows into the respective internal spaces by the partition portion 14, it is possible to secure an appropriate flow rate, it is possible to separate the bubbles without changing the capacity of the reserve tank. In other words, in the reserve tank 10, the flow rate for each internal space can be reduced as compared with the case where the partition portion 14 is not provided, so that the bubbles can be separated.

In the case where the partition portion 14 is not provided in the reserve tank, in order to separate the air bubbles of the coolant, it is necessary to increase the tank capacity and reduce the flow rate. On the other hand, in the reserve tank 10 according to the first embodiment, by providing the partition portion 14, it is possible to reduce the capacity of the reserve tank as compared with the case where the partition portion 14 is not provided. Therefore, it is possible to provide a reserve tank that is low in cost, light in weight, and excellent in mounting space efficiency.

Here, attention is paid to the center position of the outlet 13 and the center position of the swirling flow V1, V2. As shown in FIGS. 1 and 2, the partition portion 14 is provided directly above the outlet 13 so as to divide the coolant flowing out from the outlet 13 equally. Therefore, the center position of the outlet 13 is a position deviated from the center position of the swirling flow V1, V2 of the coolant generated in the respective internal space S1, S2. That is, the size of the outlets 13 with respect to the respective internal spaces S1, S2 of the gas-liquid separation unit becomes equal, and it is possible to uniformly suppress the separated air bubbles from flowing out of the outlets 13 without being biased in the respective internal spaces S1, S2. Therefore, the cooling performance can be improved.

Further, in order to further improve the cooling performance, when the flow rate of the coolant is increased, the difference between the flow rate on the outer side and the flow rate on the inner side of the swirling flow V1, V2 becomes larger. In such cases, as compared with FIGS. 2 and 3, the height of the liquid level WS1, WS2 of the coolant becomes lower, and the liquid level becomes steeper from the inside of the swirling flow to the outside of the swirling flow. Even if the height of the liquid level WS1, WS2 decreases, the center position of the outlet 13 is a position deviated from the center position of the swirling flow V1, V2 of the coolant generated in the respective internal space S1, S2, so that it is possible to suppress the separated air bubbles from flowing out of the outlet 13.

That is, the partition portion 14 is provided inside the gas-liquid separation unit 11, and the center position of the outlet 13 is set to a position deviated from the center position of the swirling flow V1, V2 of the coolant generated in the respective internal space S1, S2, whereby the cooling performance can be further improved.

Here, the partition portion 14 may be provided with a communication port (not shown). The communication port (not shown) is a hole for adjusting the quantity of the coolant in the internal space S1, S2, the liquid level, and the ratio of the space above the gas-liquid separation unit 11. Thus, the variation in the liquid level of the respective internal spaces S1, S2 of the reserve tank is the same as that of the reserve tank when the partition portion 14 is not provided. When the vehicle starts and stops, the flow rate is low, but the liquid level of the coolant stored in the reserve tank 10 tends to fluctuate due to the front, rear, left, and right movements. In such a case, if the outlet 13 is provided in the vicinity of the side surface of the gas-liquid separation unit 11, there is a possibility that the air bubbles contained in the coolant may flow out from the outlet 13 due to the influence of the liquid level fluctuation.

On the other hand, as shown in FIGS. 1 to 3, when the outlet 13 is provided at the center position of the gas-liquid separation unit 11, it is difficult to be affected by the liquid level fluctuation, so that it is possible to suppress the air bubbles contained in the coolant from flowing out from the outlet 13. In other words, in the reserve tank 10, it is possible not only to increase the flow rate of the coolant but also to prevent the separated air bubbles from flowing out from the outlet 13 even when the coolant has a low flow rate.

### Modification

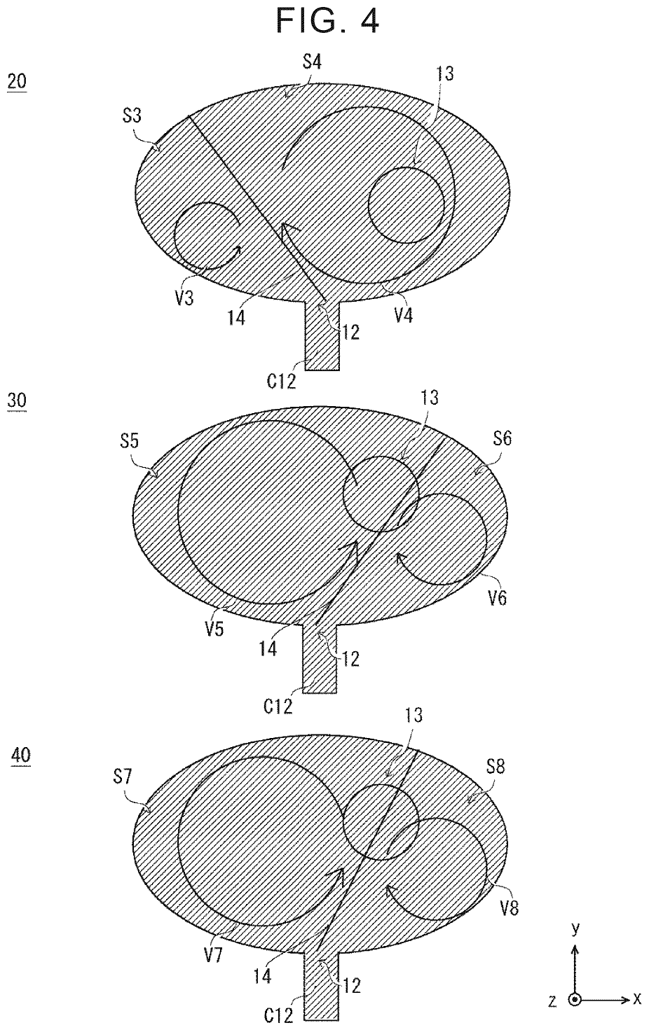

Heretofore, an example of a reserve tank has been described in which the partition portion 14 is provided so as to divide the coolant flowing out from the inlet 12 equally, and further the partition portion 14 is provided so as to divide the coolant flowing out from the outlet equally. However, the present disclosure is not limited thereto, and may be a reserve tank according to the following modification. A reserve tank according to a modified example will be described with reference to FIG. 4. FIG. 4 is a plan view (xy plan view) of a reserve tank according to a modification. In the reserve tanks 20, 30, and 40 according to the modification illustrated in FIG. 4, the partition portion 14 is provided inside the gas-liquid separation unit 11 so as to divide the coolant flowing in from the inlet 12.

The reserve tank 20 according to the modification shown in FIG. 4 will be described. In the reserve tank 20 shown in FIG. 4, the position of the outlet 13 and the position of the partition portion 14 are different from those of the reserve tank 10 shown in FIG. 1. Further, in the reserve tank 20, the size of the internal space S3 and the internal space S4 is different due to the position of the partition portion 14 being different from that of the reserve tank 10. The other configurations are the same as those of the reserve tank 10 shown in FIG. 1, and thus description thereof will be omitted.

As illustrated in FIG. 4, in the reserve tank 20, the partition portion 14 is provided inside the gas-liquid separation unit 11 so as to divide the coolant flowing in from the inlet 12. As shown in FIG. 4, an internal space S3, S4 is formed in the gas-liquid separation unit 11 of the reserve tank 20 by the partition portion 14. The partition portion 14 may be provided so as to divide the coolant flowing in from the inlet 12 so as to divide the ratio of the internal space S3 in the gas-liquid separation unit 11 and the ratio of the internal space S4 in the gas-liquid separation unit 11.

In the reserve tank 20 shown in FIG. 4, in order to improve the cooling performance, the coolant from the inlet 12 is divided and flows into the respective internal spaces S3, S4 even if the flow rate of the coolant is increased. Therefore, the swirling flow V3, V4 is generated in the internal space S3, S4 while ensuring an appropriate flow velocity. As described above, even if the coolant is equally divided and does not flow into the internal spaces, an appropriate flow rate can be secured, and the bubbles can be separated without changing the capacity of the reserve tank.

Further, in the reserve tank 20 illustrated in FIG. 4, the partition portion 14 is not provided directly above the outlet 13 as compared with the reserve tank 10 illustrated in FIG. 1. However, the center position of the outlet 13 is deviated from the center position of the swirling flow V3, V4 of the coolant generated in the respective internal space S3, S4. Thus, even if the partition portion 14 is not provided so as to divide the coolant flowing out from the outlet 13, if the center position of the outlet 13 is a position deviated from the center position of the swirling flow V3, V4, it is possible to suppress the separated air bubbles from flowing out from the outlet 13. Therefore, the cooling performance can be improved.

Here, like the reserve tank 30 shown in FIG. 4, the partition portion 14 may be provided inside the gas-liquid separation unit 11 so as to divide the coolant flowing in from the inlet 12, and the partition portion 14 may be provided so as to divide the coolant flowing out from the outlet 13. As shown in FIG. 4, an internal space S5, S6 is formed in the gas-liquid separation unit 11 of the reserve tank 30 by the partition portion 14. The partition portion 14 may be configured to determine the ratio of the internal space S5 to the inside of the gas-liquid separation unit 11 and the ratio of the internal space S6 to the inside of the gas-liquid separation unit 11. The partition portion 14 may be provided so as to divide the coolant flowing in from the inlet 12 and the coolant flowing out from the outlet 13.

In the reserve tank 30 shown in FIG. 4, when the flow rate of the coolant is increased in order to improve the cooling performance, a swirling flow V5, V6 is generated in the respective internal space S5, S6. The center position of the outlet 13 is a position deviated from the center position of the swirling flow V5, V6 of the coolant generated in the respective internal space S5, S6.

Even in such a configuration of the reserve tank 30, an appropriate flow rate can be secured for the respective internal space S5, S6, and bubbles can be separated without changing the volume of the reserve tank. Further, since the center position of the outlet 13 is a position deviated from the center position of the swirling flow V5, V6 of the coolant generated in the respective internal space S5, S6, it is possible to suppress the separated air bubbles from flowing out of the outlet 13 and to improve the cooling performance.

It should be noted that, as in the reserve tank 40 shown in FIG. 4, the partition portion 14 may be provided inside the gas-liquid separation unit 11 so as to divide the coolant flowing in from the inlet 12. A partition portion 14 may be provided to divide the coolant flowing out of the outlet 13 equally.

In the reserve tank 40, the respective internal spaces S7, S8 are formed in the gas-liquid separation unit 11 by the partition portion 14. In the reserve tank 40, swirling flow V7, V8 are generated in the respective internal spaces S7, S8. In the reserve tank 40, the configuration for separating the bubbles and the configuration for suppressing the separated bubbles from flowing out from the outlet 13 are the same as those of the reserve tanks 20 and 30, and thus description thereof will be omitted. In addition, in the reserve tanks 20, 30, and 40 illustrated in FIG. 4, the number of the partition portions 14 is one, but a plurality of partitions may be provided.

As described above, in the reserve tank according to the modified example, since the coolant from the inlet is divided, the swirling flow is generated while securing an appropriate flow rate, and the bubbles can be separated in the gas-liquid separation unit. Further, in the reserve tank according to the modified example, since the center position of the outlet is deviated from the center position of the swirling flow, it is possible to suppress the separated air bubbles from flowing out from the outlet, and thus it is possible to improve the cooling performance.

### Second Embodiment

### Shielding Plate

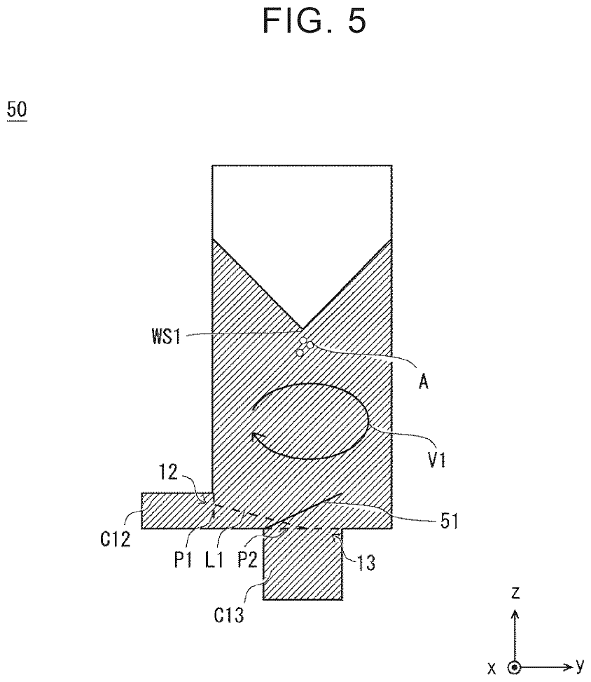

A reserve tank according to a second embodiment will be described with reference to FIG. 5. FIG. 5 is a cross-sectional view (yz cross-sectional view) of the reserve tank according to the second embodiment. In the reserve tank 50 according to the second embodiment, the configurations of the gas-liquid separation unit 11, the inlet 12, the outlet 13, and the partition portion 14 are the same as those of the reserve tank 10 according to the first embodiment, and thus description thereof will be omitted. Here, the shielding plate 51 will be described.

The shielding plate 51 is provided so as to protrude upward from the bottom surface of the gas-liquid separation unit 11 between the inlet 12 and the outlet 13. The shielding plate 51 will be described in more detail with reference to FIG. 5.

The shielding plate 51 is provided on the bottom surface of the gas-liquid separation unit 11 so as to block a straight line connecting the predetermined position of the inlet 12 and the predetermined position of the outlet 13. The predetermined position of the inlet 12 is any position of the inlet 12, and corresponds to the position P1 in the embodiment illustrated in FIG. 5. The predetermined position of the outlet 13 is any position of the outlet 13, and corresponds to the position P2 in the embodiment illustrated in FIG. 5. As shown in FIG. 5, a straight line connected to the position P1 and the position P2 is a straight line L1, and the shielding plate 51 is provided on the bottom surface of the gas-liquid separation unit 11 so as to block the straight line L1.

As described above, by providing the shielding plate 51, it is possible to prevent the coolant flowing into the gas-liquid separation unit from flowing out of the outlet 13 as it is from the inlet 12. In other words, even when the coolant from the inlet 12 contains bubbles, the shielding plate 51 allows the coolant from the inlet 12 to flow into the gas-liquid separation unit 11 so as to stagnate, and the bubbles can be separated by the swirling flow V1, V2. Then, the coolant from which the bubbles are separated flows out from the outlet 13.

That is, in the reserve tank 50, air bubbles can be suppressed from being contained in the coolant flowing out from the outlet 13 toward the circulation path and the cooling target, so that the cooling performance can be improved.

### Shape of the Shielding Plate

Note that the shape of the shielding plate 51 is not limited to the example shown in FIG. 5, and may be any shape as long as it protrudes upward from the bottom surface of the gas-liquid separation unit 11. The angle protruding above the shielding plate 51 may be any angle. In the example illustrated in FIG. 5, the number of the shielding plates 51 is one, but a plurality of shielding plates may be provided.

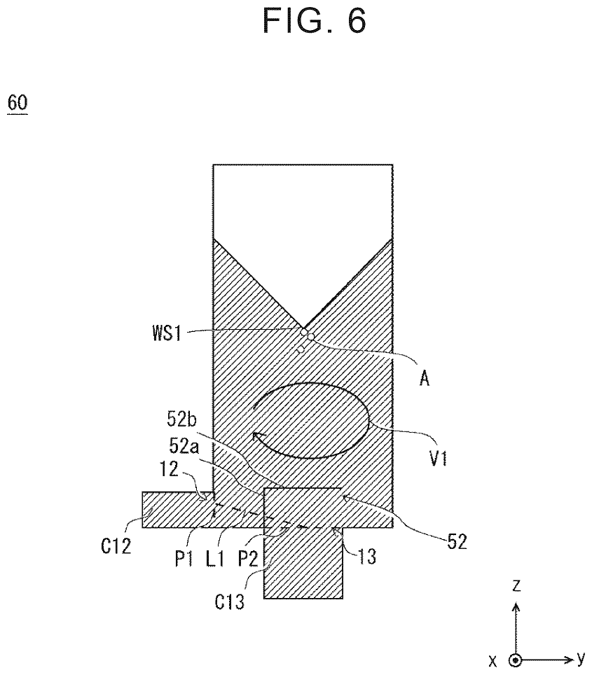

Referring to FIG. 6, another example of the shape of the shielding plate is shown. FIG. 6 is a cross-sectional view (yz cross-sectional view) of the reserve tank according to the second embodiment. The reserve tank 60 shown in FIG. 6 has a different shape of the shielding plate 51 than the reserve tank 50 shown in FIG. 5, and other configurations are the same, and thus description thereof will be omitted.

As shown in FIG. 6, the shielding plate 52 is provided so as to protrude upward from the bottom surface of the gas-liquid separation unit 11 between the inlet 12 and the outlet 13. More specifically, as shown in FIG. 6, the shielding plate 52 includes a shielding plate portion 52a and a shielding plate portion 52b. The shielding plate portion 52a is parallel to the z-axis, and the shielding plate portion 52b is parallel to the y-axis. That is, the shielding plate 52 is provided on the bottom surface of the gas-liquid separation unit 11 between the inlet 12 and the outlet 13 so as to cover a part of the edge portion of the outlet 13.

Even in the case of the shielding plate 52 having such a shape, in the reserve tank 60, it is possible to prevent air bubbles from being contained in the coolant flowing out from the outlet 13 toward the circulation path and the cooling target, and thus it is possible to improve the cooling performance.

The present disclosure is not limited to the above-described embodiment, and can be appropriately modified without departing from the scope of the present disclosure.

What is claimed is:

1. A reserve tank that stores coolant of a vehicle, comprising:
a gas-liquid separation unit in a substantially cylindrical column shape;
an inlet provided in a side surface of the gas-liquid separation unit to allow the coolant to flow into an inside of the gas-liquid separation unit; and
an outlet provided in a bottom surface of the gas-liquid separation unit to allow the coolant to flow out of the inside of the gas-liquid separation unit, wherein:
a plurality of internal spaces is formed in the gas-liquid separation unit by providing a partition portion inside the gas-liquid separation unit so as to divide the coolant flowing in from the inlet; and
a center position of the outlet is a position deviated from a center position of a swirling flow of the coolant generated in each of the internal spaces.

2. The reserve tank according to claim 1, wherein the partition portion is provided so as to divide the coolant flowing out from the outlet.

3. The reserve tank according to claim 1, wherein the partition portion is provided so as to equally divide the coolant flowing out from the outlet.

4. The reserve tank according to claim 3, wherein:
the partition portion is provided so as to equally divide the coolant flowing out from the inlet; and
the center position of the outlet is the same position as a center of the gas-liquid separation unit.

5. The reserve tank according to claim 1, wherein a shielding plate that protrudes upward from the bottom surface of the gas-liquid separation unit is provided between the inlet and the outlet.
